(19) United States
(12) Patent Application Publication
(10) Pub. No.: US 2016/0373996 A1
(43) Pub. Date: Dec. 22, 2016

(54) ROUTING GATEWAY SELECTING METHOD, CONTROLLER AND VEHICLES NETWORK SYSTEM

(71) Applicants: Industrial Technology Research Institute, Hsinchu (TW); National Chiao Tung University, Hsinchu City (TW)

(72) Inventors: Jen-Shun Yang, Hsinchu County (TW); Jyh-Cheng Chen, Taichung City (TW); Pei-Chia Hsu, New Taipei City (TW); Wei-Chen Sim, Hsinchu City (TW)

(21) Appl. No.: 14/884,771

(22) Filed: Oct. 16, 2015

(30) Foreign Application Priority Data
Jun. 17, 2015 (TW) 104119558

(51) Int. Cl. H04W 40/02; H04W 24/08

(52) U.S. Cl. CPC H04W 40/026; H04W 24/08; H04W 40/18

(57) ABSTRACT

The disclosure proposes a routing gateway selecting method, a controller and a vehicles network system. The method is adapted to a controller disposed on a fleet of vehicles configured by a plurality of vehicles, and the controller is configured to select a routing gateway among a plurality of gateways for routing an access point (AP). The routing gateway selecting method includes: predicting a bandwidth of each of the gateways; calculating a transmission cost of each of the gateways based on a load condition and the bandwidth of each of the gateways and a hop count between each of the gateways and the AP; and selecting the routing gateway among the gateways for routing the AP according to the transmission cost of each of the gateways.

### CROSS-REFERENCE TO RELATED APPLICATION

This application claims the priority benefit of Taiwan application no. 104119558, filed on Jun. 17, 2015. The entirety of the above-mentioned patent application is hereby incorporated by reference herein and made a part of this specification.

### TECHNICAL FIELD

The disclosure relates to a routing gateway selecting method, a controller and a vehicles network system.

### BACKGROUND

In many countries, common roads, railways, highways, high-speed railways are very important tools as a vehicles network gradually becomes even more complex and intricate each day. With developments of the communication technology and popularization of the communication devices, demands for vehicles-related network technologies rapidly increases in scenarios involving high moving speed. In the case of the high-speed railways, a highest speed per hour is approximately 280 KM per hour. With such high moving speed, a variation range of a signal quality within a short period of time is considerably large. Also, under the influence from the Doppler effect, a decoding error rate at a receiver may raise to cause mobile devices to conduct a large number of attempts for re-transmitting data due to connection lost. In this case, the network already experiencing unstable signals needs to handle more processing data, resulting in that all users are unable to utilize the network smoothly. As such, it has become an important research and development topic as how to provide improvements for situations where network congestion occurs.

### SUMMARY

Accordingly, the present disclosure provides a routing gateway selecting method, a controller and a vehicle network system, which are capable of dynamically adjusting a routing method of the vehicle network system to improve a transmission efficiency of the entire vehicles network.

The present disclosure provides a routing gateway selecting method, which is adapted to a controller configured to select a routing gateway among a plurality of gateways for routing an access point. The routing gateway selecting method includes: predicting a bandwidth of each of the gateways; calculating a transmission cost of each of the gateways based on a load condition and the bandwidth of each of the gateways and a hop count between each of the gateways and the access point; and selecting the routing gateway among the gateways for routing the access point according to the transmission cost of each of the gateways, wherein the controller is disposed on a fleet of vehicles configured by a plurality of vehicles.

The present disclosure provides a controller, which is configured to select a routing gateway among a plurality of gateways for routing an access point. The controller includes an access unit and a processing unit. The access unit stores a plurality of modules. The processing unit is electrically connected to the access unit for accessing and executing the modules. The modules include a prediction module, a calculation module and a selection module. The prediction module predicts a bandwidth of each of the gateways. The calculation module calculates a transmission cost of each of the gateways based on a load condition and the bandwidth of each of the gateways and a hop count between each of the gateways and the access point. The selection module selects the routing gateway among the gateways for routing the access point according to the transmission cost of each of the gateways.

The present disclosure provides a vehicle network system, which includes a plurality of access points, a plurality of gateways, and one or more controllers. The one or more controllers control all or part of gateways among the gateways and all or part of access points among the access points, and are configured for: predicting a bandwidth of each of the controlled gateways; calculating a transmission cost of each of the gateways for routing the access point based on a load condition and the bandwidth of each of the gateways and a hop count between each of the gateways and the access point; and selecting a routing gateway among the controlled gateways for routing each of the controlled access points according to the transmission cost of each of the controlled gateways, wherein the controller is disposed on a fleet of vehicles configured by a plurality of vehicles.

Based on the above, according to the routing gateway selecting method, the controller and the vehicle network system proposed by the present disclosure, the controller additionally disposed on the fleet of vehicles may be used to calculate the transmission cost of each of the gateways for routing the access point, which may be used to select the suitable routing gateway for the access point.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B are schematic diagrams illustrating scenarios of common vehicles network systems.

FIG. 2 is a schematic diagram illustrating a vehicles network system according to an embodiment of the present disclosure.

FIG. 3 is a flowchart illustrating a routing gateway selecting method according to an embodiment of the present disclosure.

FIG. 4 is a flowchart for predicting a channel quality based on an autoregressive model mechanism according to an embodiment of the present disclosure.

FIG. 5 is a flowchart for predicting a channel quality based on a weighted moving average mechanism according to an embodiment of the present disclosure.

FIG. 6 is a schematic diagram for selecting the routing gateway according to the transmission cost according to an embodiment of the present disclosure.

FIG. 7A to FIG. 7C are schematic diagrams of the load balance according to multiple embodiments of the present disclosure.

FIG. 8 is a schematic diagram illustrating a vehicles network system having multiple controllers according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

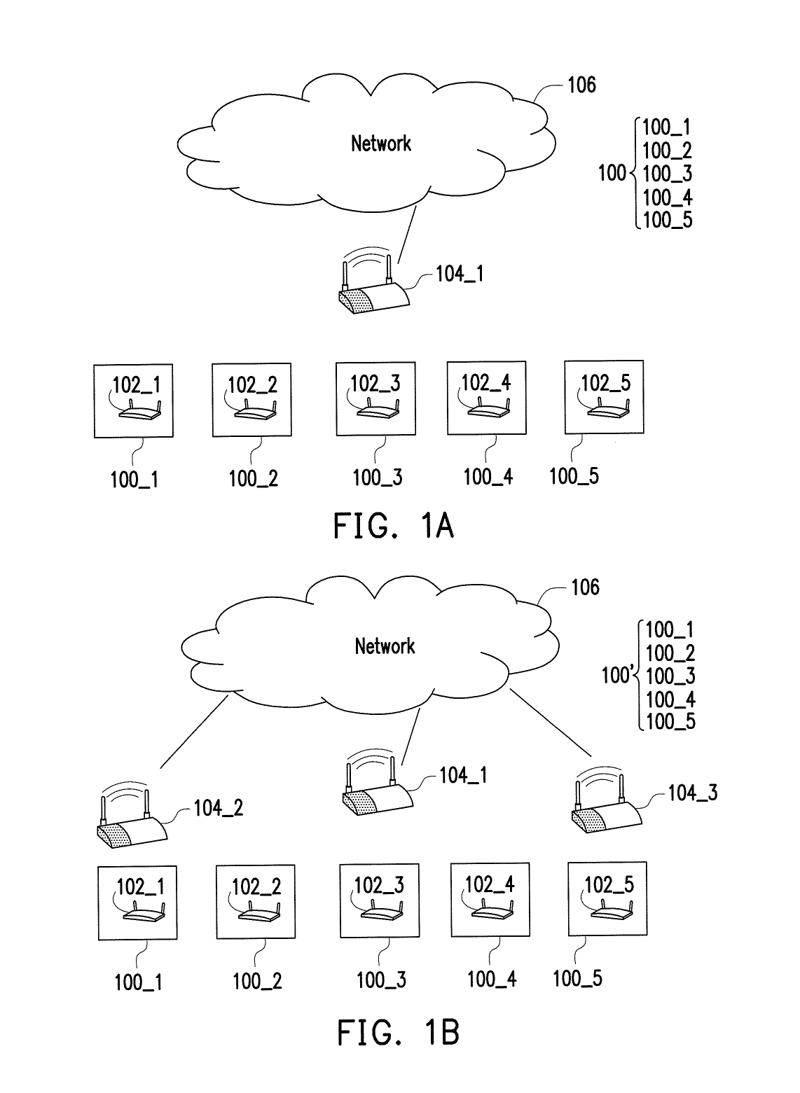

FIG. 1A is a schematic diagram illustrating a scenario of a common vehicles network system. A fleet of vehicles 100 of FIG. 1A and any fleet of vehicles mentioned in the present disclosure are referred to a fleet of vehicles configured by a plurality of vehicles. Said fleet of vehicles may be a railway train, a high-speed railway train or other fleet of vehicles composed of multiple cars, and the vehicles may be cars of the railway train, cars of the high-speed railway train or cars of the other fleet of vehicles composed of multiple cars; or said fleet of vehicles may be a motorcade composed of multiple cars, and the cars may be vehicles including an automobile, a truck, a bus and so on, but the present disclosure is not limited to the above. For example, the fleet of vehicles 100 may include 5 cars or other vehicles (collectively known as vehicles hereinafter), which are vehicles 100_1 to 100_5. A network transmission method used for the vehicles is to mainly constitute an integrated network through a wireless network connection. In this example, access points (APs) 102_1 to 102_5 may be disposed on the vehicles 100_1 to 100_5 respectively, and configured to provide network access functions to passengers in each of the vehicles 100_1 to 100_5. For instance, the access point 102_1 is provided for the passengers in the vehicle 100_1 to access by using a mobile device (e.g., a cell phone, a tablet computer, a notebook computer or other similar devices); the access point 102_2 is provided for the passengers in the vehicle 100_2 to access by using said mobile device; and the rest of the access points 102_3 to 102_5 are provided for the same purpose.

As shown by FIG. 1A, the fleet of vehicles 100 may be disposed with one outbound gateway 104_1 (e.g., a customer premise equipment (CPE) gateway) on the vehicle 1003. The gateway 104_1 may be connected to the access points 102_1 to 102_5, and served as a communication medium between the access points 102_1 to 102_5 and the network 106. A network 106 is, for example, a long term evolution (LTE), a worldwide interoperability for microwave access (WiMAX), a third generation mobile communication network, a fourth generation mobile communication network or other similar networks, but the present disclosure is not limited to the above. It should be understood that, although a configuration of the network 106 is not clearly illustrated in FIG. 1A, the configuration may substantially include corresponding network entities according a communication standard being used. For instance, if the LTE is used between the network 106 and the gateway 104_1 for communication, the network 106 may include network entities such as an evolved Node B (eNB), a mobility management entity (MME), a serving gateway (S-GW) and a packet data network gateway (P-GW), but the present disclosure is not limited to the above.

In this example, because the fleet of vehicles 100 only includes the outbound gateway 104_1, a channel quality between the gateway 104_1 and the network 106 changes rapidly while the fleet of vehicles 100 is moving. In other words, a changing rate of a channel capacity between the gateway 104_1 and the network 106 is considerably high. Also, no other gateways can be used to share traffic loads when the traffic loads of the gateway 104_1 are overloaded, so that all the passengers on the vehicle suffer the poor network quality. In an embodiment, the channel quality may be represented by a carrier to interference and noise ratio (CINR), a carrier to noise ratio (CNR), a signal to noise ratio (SNR) and/or a signal to interference and noise ratio (SINR), but the present disclosure is not limited thereto.

In addition, even if a redundancy gateway is additionally disposed at where the gateway 104_1 is disposed (i.e., the vehicle 100_3) to share the traffic loads of the gateway 104_1, a transmission efficiency of the entire vehicles network still fails to achieve an effectiveness of a channel quality diversity since the channel quality of the redundancy gateway is similar to that of the gateway 104_1.

FIG. 1B is a schematic diagram illustrating another scenario of a common vehicles network system. Unlike FIG. 1A, in the scenario of FIG. 1B, a gateway 104_2 and a gateway 104_3 are further disposed on the vehicle 100_1 and the vehicle 100_5 of a fleet of vehicles 100′ respectively. In order to balance distribution of traffic loads in each of the gateways 104_1 to 1043, a common load balance controller (not illustrated) connected the gateways 104_1 to 104_3 may be disposed on the fleet of vehicles 100′. After said load balance controller is disposed, each of data flows from the access points 102_1 to 102_5 must be centralized at the load balance controller, so that the load balance controller may determine each of the data flows is transmitted to the network 106 through which one of the gateways 104_1 to 104_3. In this case, although the effectiveness of the channel quality diversity may be achieved, the network congestion may occur since a transmission path of each of the data flows is substantially extended.

For instance, it is assumed that the load balance controller is disposed on the vehicle 105_5 (e.g., the vehicle located at a last position in a moving path, such as a last car of the train). In this case, when the access point 102_1 of the vehicle 100_1 (e.g., the vehicle located at a first position in the moving path, such as a first car of the train) intends to transmit the data flow, the data flow must be transmitted to the load balance controller disposed on the vehicle located at the last position first and then transmitted back to the gateway 104_2 disposed on the vehicle located at the first position before being transmitted to the network 106. Nonetheless, for said data flow, the most efficient transmission method is to directly use the gateway 104_2 also disposed on the vehicle located on the first position for transmission. In other word, if the distribution of the traffic loads between the gateways 104_1 to 104_3 is simply balanced by using only the common load balance controller, the transmission efficiency of the entire vehicles network may be reduced to be even worse than that of the example in FIG. 1A.

In view of the foregoing example, it can be known that, when multiple gateways are disposed on the fleet of vehicles, some other mechanisms need to be developed to select a routing gateway for routing the data flows of the gateways more efficiently.

The present disclosure propose a new vehicles network system, which is capable of dynamically adjusting selection of the routing gateway for routing the data flows from multiple gateways according to environment variable, so that the transmission efficiency of the entire vehicles network may be improved and the packet loss rate may be reduced while achieving an effectiveness of load balance.

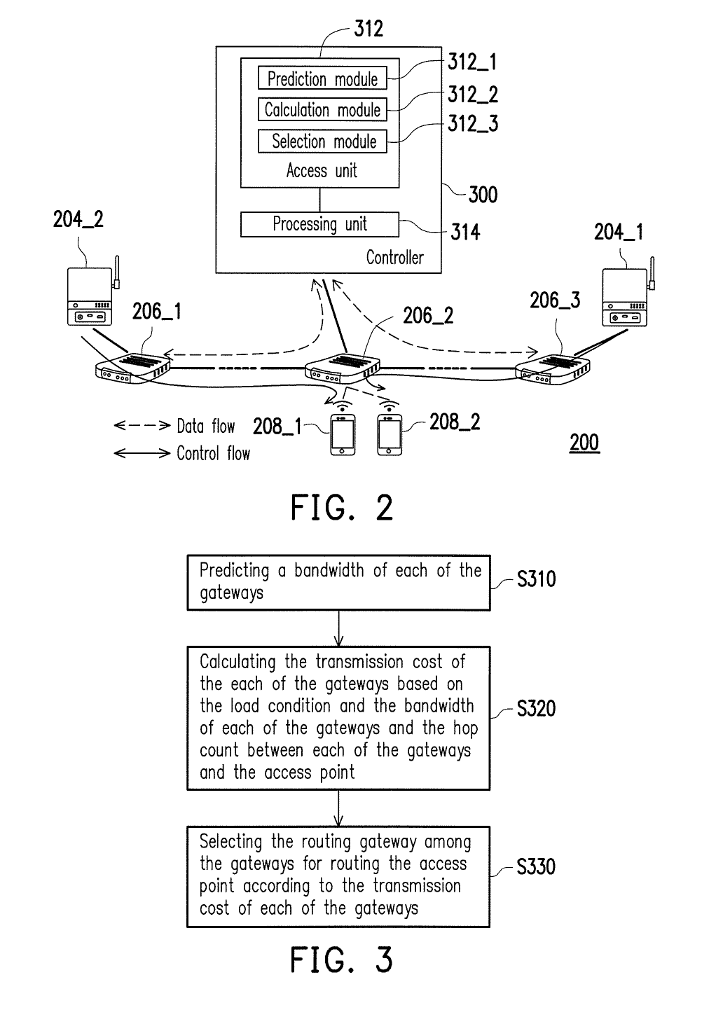

Referring to FIG. 2, FIG. 2 is a schematic diagram illustrating a vehicles network system according to an embodiment of the present disclosure. In the present embodiment, a vehicles network system 200 is, for example, a network architecture on a fleet of vehicles having a plurality of vehicles. The vehicles network system 200 includes a controller 300, gateways 204_1 to 204_2 and access points 206_1 to 206_3. As similar to the configuration in the foregoing embodiments, each one of the gateways 204_1 to 204_2 and the access points 206_1 to 206_3 may be disposed on, for example, one specific vehicle of the fleet of vehicles. However, unlike the foregoing embodiments, the present embodiment is further disposed with the controller 300 electrically connected or wireless connected to the gateways 204_1 to 204_2 and the access points 206_1 to 206_3, which may be disposed on, for example, one specific vehicle of the fleet of vehicles.

The controller 300 is, for example, a software-defined network (SDN) controller which supports OpenFlow, and the SDN controller may directly use a control signal to control and request a software-defined network controlled end in the gateway to provide a load condition. The controller 300 may include an access unit 312 and a processing unit 314. The access unit 312 is, for example, a memory, a hard disk or other devices capable of storing or accessing data, and may be configured to record a plurality of program codes or modules, and data. The processing unit 314 is electrically connected to the access unit 312. The processing unit 314 can be a processor for general purposes, a processor for special purposes, a conventional processor, a data signal processor, a plurality of microprocessors, one or more microprocessors, controllers, microcontrollers and Application Specific Integrated Circuit (ASIC) which are combined with a core of the digital signal processor, a Field Programmable Gate Array (FPGA), any other integrated circuits, a state machine, a processor based on Advanced RISC Machine (ARM) and similar products.

Access points 206_1 to 206_3 are capable of integrating functions of a switch that supports OpenFlow, and exchanging data with the controller 300 based on the OpenFlow protocol by using, for example, functions of a SDN switch. Further, each of the access points 206_1 to 206_3 may also be disposed with a WiFi base station. In other embodiments, the SDN switch may also be implemented by a device independent from the access points 206_1 to 206_3, and configured to assist the access points 206_1 to 206_3 to communicate with the controller 300. FIG. 2 illustrates an embodiment of the transmission paths of data flow and control flow and the concept of separating the data plane and the control plane based on the architecture of the SDN network.

In the present embodiment, under the architecture of FIG. 2, after locating the routing gateway suitable for routing the data flows of the access points 206_1 to 206_3 based on the routing gateway selecting method proposed by the present disclosure, the controller 300 may inform each of the access points 206_1 to 206_3 of a result thereof by the control flow. Subsequently, each of the access points 206_1 to 206_3 may directly send the data flow from a user equipment (UE) to the corresponding gateway. Take the access point 206_2 as an example, assuming that the routing gateway suitable for routing the data flow of the access point 206_2 located by the controller 300 based on the method of the present disclosure is the gateway 204_1, the controller 300 may then inform the access point 206_2 of such result by the control flow. Subsequently, when the data flows are received from UEs 208_1 and 208_2 served by the access point 206_2, the access point 206_2 may directly forward the data flows to the gateway 204_1, so that the data flows may then be sent to an external network such as the LTE network via the gateway 204_1. In other words, the data flows do not go through redundant transmission paths as similar to what illustrated in FIG. 1B, such that the transmission efficiency of the entire vehicles network may be improved.

In the present embodiment, the processing unit 314 is capable of accessing and executing a prediction module 312_1, a calculation module 312_2 and a selection module 312_3 in order to perform the routing gateway selecting method proposed by the present disclosure.

FIG. 3 is a flowchart illustrating a routing gateway selecting method according to an embodiment of the present disclosure. The method proposed in FIG. 3 may be implemented by using the controller 300 of FIG. 2, so as to locate a routing gateway among the gateways 204_1 to 204_2 which is suitable for routing each of the access points 206_1 to 206_3. Detailed steps of the method are described below with reference to each element depicted in FIG. 2. Further, in order to facilitate in describing the spirit of the present disclosure more clearly, a mechanism used by the controller 300 to select the routing gateway for one access point (e.g., the access point 206_1) is provided below. Based on aforesaid mechanism, mechanisms used by the controller 300 to select the routing gateway for other access points (e.g., the access points 206_2 to 206_3) should be deduced accordingly.

In step S310, the prediction module 312_1 may predict a bandwidth of each of the gateways 204_1 to 204_2. In an embodiment, the prediction module 312_1 may predict a channel quality of each of the gateways 204_1 to 204_2 through a specific mechanism, search an adaptive modulation and coding scheme (AMC scheme) corresponding to the channel quality of each of the gateways 204_1 to 204_2, and estimate the bandwidth of each of the gateways 204_1 to 204_2 based on the AMC scheme. For example, a specification of the LTE defines 16 AMC schemes (or known as modulation and coding schemes (MCSs)) which are corresponding to 16 different channel quality indicators (CQIs), respectively. In this case, the prediction module 312_1 may determine which one of the CQIs a predicted channel quality belongs to, so as to locate the AMC scheme corresponding to the CQI. A mechanism used by the prediction module 312_1 to predict the channel quality of each of gateways 204_1 to 204_2 is introduced as follows.

In an embodiment, the prediction module 312_1 may establish a channel quality estimation model of each of the gateways 204_1 to 204_2 based on historical information of both the gateways 204_1 to 204_2 and the fleet of vehicles. The historical information of the fleet of vehicles includes, for example, a moving route and a moving speed of the fleet of vehicles in each section of the moving route. The historical information of each of the gateways 204_1 to 204_2 includes, for example, the channel quality of each of the gateways 204_1 to 204_2 measured in advance on the moving route of the fleet of vehicles.

For example, in the gateway 204_1, the prediction module 312_1 may measure the channel quality of the gateway 204_1 in each section of the moving route of the fleet of vehicles in advance. Subsequently, the prediction module 312_1 may establish a reference table of the channel qualities and the sections (i.e., which may be used as the channel quality estimation model of the gateway 204_1) based on the measured result. As for the other gateway (e.g., the gateway 204_2), the prediction module 312_1 may also establish the corresponding channel quality estimation model according to the foregoing teachings.

After establishing the channel quality estimation model of each of the gateways 204_1 to 204_2, the prediction module 312_2 may obtain current movement information of the fleet of vehicles and current channel information of each of the gateways 204_1 to 204_2 when the fleet of vehicles is practically moving. The moving information is, for example, information obtained by a global positioning system (GPS) system disposed on the fleet of vehicles, such as the section that the fleet of vehicle is currently located, the moving speed and the like. The current channel information of each of the gateways 204_1 to 204_2 is, for example, a current channel quality of each of the gateways 204_1 to 204_2 being measured, but the present disclosure is not limited thereto.

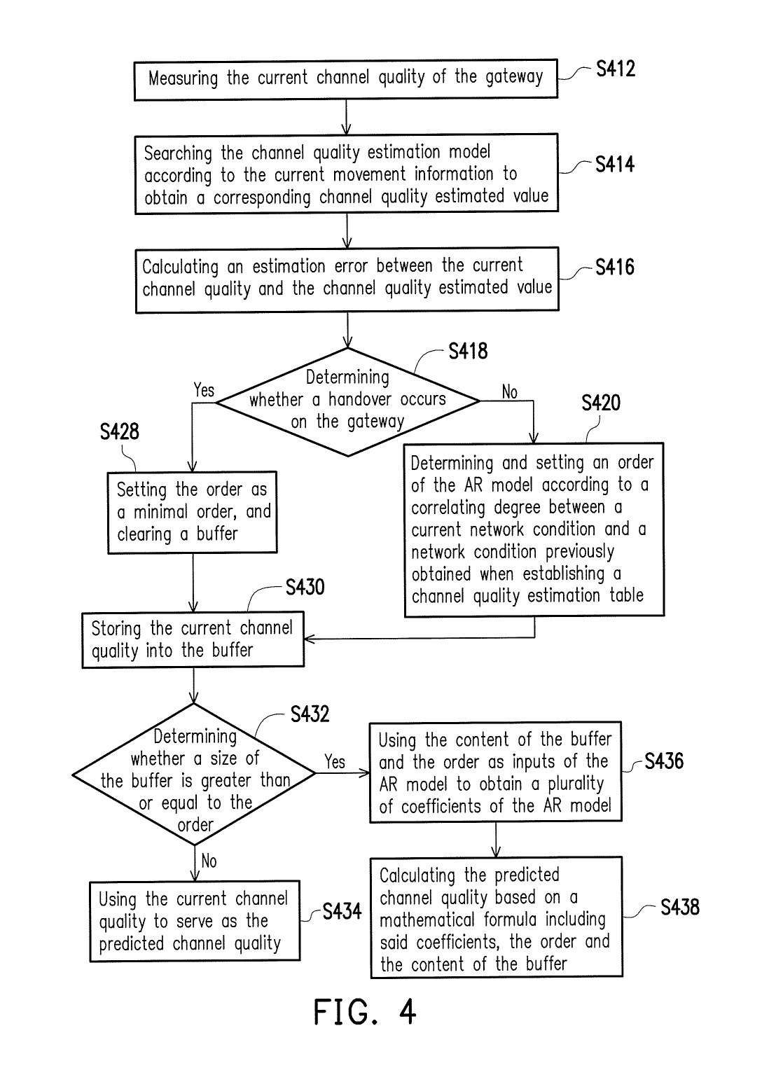

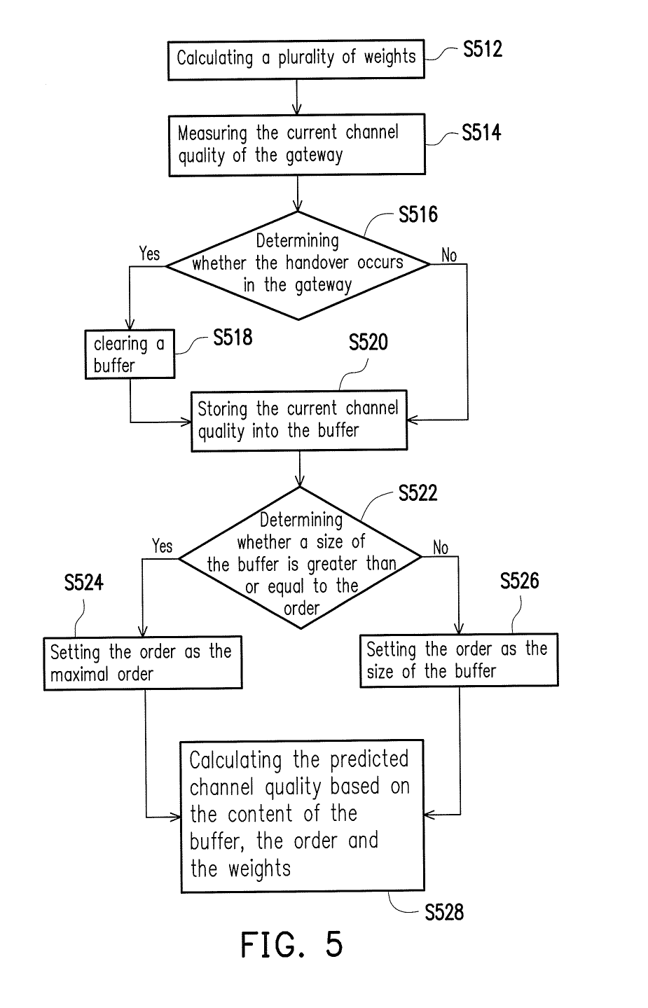

Subsequently, in an embodiment, according to contents of FIG. 4 and/or FIG. 5, the prediction module 312_1 may predict the channel quality of each of the gateways 204_1 to 204_2 based on the current movement information, the current channel information and the channel quality estimation model of each of the gateways 204_1 to 204_2. For clearer description, a mechanism used by the prediction module 312_1 to predict one single gateway 204_1 is illustratively introduced as an example below, and mechanisms used by the prediction module 312_1 to predict the other gateway 204_2 should be deduced from such example.

Referring to FIG. 4, FIG. 4 is a flowchart for predicting a channel quality based on an autoregressive (AR) model mechanism according to an embodiment of the present disclosure, in which said AR model mechanism may be a dynamic AR model mechanism or a static AR model mechanism. First of all, in step S412, the prediction module 312_1 may measure the current channel quality (e.g., the CINR) of the gateway 204_1. Hereinafter, Xₜ is used to represent the current channel quality, wherein t is an index value of a time point. In other words, Xₜ may be regarded as the channel quality measured at a t^{th} time point.

In step S414, the prediction module 312_1 may search the channel quality estimation model according to the current movement information to obtain a corresponding channel quality estimated value (hereinafter, represented by X̅ₜ). For instance, the prediction module 312_1 may search the reference table according to the section where the fleet of vehicles is currently located, so as to locate the channel quality estimated value (\hat{X}ₜ) of the gateway 204_1 corresponding to the section.

In case the dynamic AR model is adopted, in step S416, the prediction module 312_1 may calculate an estimation error between the current channel quality and the channel quality estimated value. For instance, the estimation error (hereinafter, represented by Eₜ) may be represented by “Eₜ=|Xₜ−\hat{X}ₜ”, but the present disclosure is not limited thereto. In step S418, the prediction module 312_1 may determine whether a handover occurs on the gateway 204_1; and step S416 may be skipped if the static AR model is adopted.

If the handover does not occur in the gateway 204_1, in step S420, the prediction module 312_1 may determine and set an order (represented by p) of the AR model according to a correlating degree between a current network condition and a network condition previously obtained when establishing a channel quality estimation model, and then proceed to execute step S430. The order may be any positive integer greater than Oₘᵢₙ preset by designers.

Referring back to step S418, if the handover occurs on the gateway 204_1 when the dynamic AR model is adopted, the prediction module 312_1 may set the order as a minimal order in step S428. The minimal order may be any positive integer preset by the designers; and the prediction module 312_1 may clear a buffer in step S428 if the static AR model is adopted. The buffer may be, for example, one specific memory block in the access unit 312, and configured to record the channel qualities used to be measured (hereinafter, also known as historical channel qualities). Specifically, if the channel quality is still predicted based on the historical channel qualities after the handover occurs on the gateway 204_1, an accuracy of prediction may be reduced accordingly. Therefore, when the handover occurs on the gateway 204_1, the prediction module 312_1 may re-accumulate the parameters (e.g., p and a content of the buffer) required by the AR model by using step S428.

In step S430, the prediction module 312_1 may store the current channel quality into the buffer. Subsequently, in step S432, the prediction module 312_1 may determine whether a size of the buffer is greater than or equal to the order. The size of the buffer is, for example, a number of the historical channel qualities recorded in the buffer. If the number of the historical channel qualities recorded in the buffer is less than p, the prediction module 312_1 may use the current channel quality (i.e., Xₜ) to serve as the predicted channel quality in step S434. In brief, because the AR model requires at least a p number of the historical channel qualities in order to start the prediction, if the size of buffer is insufficient, the prediction module 312_1 may directly use Xₜ to serve as the predicted channel quality. The predicted channel quality is, for example, the channel quality estimated value of a (t+j)^{th} (j is a positive integer) time point (hereinafter, represented by \hat{X}ₜ₊ⱼ). Assuming that j is 1, the predicted channel quality may be represented by \hat{X}ₜ₊₁, and that is, the channel quality estimated value of the next time point.

On the other hand, if the number of the historical channel qualities recorded in the buffer is greater than or equal to p (i.e., the size of the buffer is sufficient) the prediction module 312_1 may use the content of the buffer and the order as inputs of the AR model to obtain a plurality of coefficients (hereinafter, represented by α₁ to αₚ) of the AR model in step S436. For instance, when the prediction module 312_1 adopts the Burg method as the AR model, the prediction module 312_1 may obtain the coefficients of the AR model based on the MATLAB function such as “a=arburg(x,p)”. In this function, x is a vector composed of each of the historical channel qualities recorded in the buffer, p is the order, and a is a vector composed of α₁ to αₚ. In other embodiments, the prediction module 312_1 may also call the corresponding MATLAB function according to the other adopted AR model (e.g., the Yule-Walker) in order to obtain the coefficients of the AR model, and description thereof is omitted hereinafter.

Subsequently, in step S438, the prediction module 312_1 may also calculate the predicted channel quality based on a mathematical formula including said coefficients, the order and the content of the buffer. In an embodiment, when the predicted channel quality is the channel quality estimated value of the next time point (i.e, \hat{X}ₜ₊ⱼ|ⱼ₌₁), said mathematical formula, for example, may be represented as:

$${\hat{X}}_{t + 1} = {\sum }_{i = 1}^{p} {α}_{i} {X}_{t - i + 1} + {ɛ}_{t} \qquad ( 1 )$$

wherein εₜ is a white noise process of the t^{th} time point, and an average value thereof is 0 and has a fixed standard deviation.

In the foregoing embodiments, the designers may use any preset positive integer greater than or equal to the minimal order to serve as a maximal order, so that the number of the historical channel qualities may be controlled. In other embodiments, the maximal order may be different values according to a property of the section where the fleet of vehicles is currently located, so as to improve the accuracy of the prediction for the channel quality. For instance, when the section where the fleet of vehicles is located belongs to a section with the channel quality being relatively more stable (e.g., plains or places which are more open), the maximal order may be set to be a larger value, so that the AR model may perform the predication with reference to more number of the historical channel qualities in the subsequent process. On the other hand, when the section where the fleet of vehicles is located belongs to a section with the channel quality being relatively less stable (e.g., mountains), the maximal order may be set to be a smaller value, so that the AR model may perform the predication with reference to less number of the historical channel qualities in the subsequent process.

In addition to the teachings in FIG. 4, the prediction module 312_1 may also predict the channel quality of the gateway 204_1 based on the mechanism shown in FIG. 5 below. Referring to FIG. 5, FIG. 5 is a flowchart for predicting a channel quality based on a weighted moving average (WMA) mechanism according to an embodiment of the present disclosure. In the present embodiment, when the predicted channel quality is the channel quality estimated value of the t^{th} time point (i.e., \hat{X}ₜ), the corresponding WMA mathematical formula may be represented as:

$${\hat{X}}_{t} = {\sum }_{i = 1}^{p} {W}_{i} {X}_{t - i} \qquad ( 2 )$$

wherein p is an order (i.e., an amount of data required for predicting \hat{X}ₜ) and W₁ to wₚ are weights.

In step S512, the prediction module may calculate a plurality of weights. In an embodiment, the weights may be obtained based on a principle for minimizing sum of square of the estimation errors. Specifically, as shown in the foregoing embodiments, the estimation error may be represented by Eₜ=|Xₜ−\hat{X}ₜ|, and the sum of square of the estimation errors (hereinafter, represented by E) in a consecutive N number of time points (N is a positive integer) may be represented as:

$$E = {\sum }_{t = 1}^{N} {( {X}_{t} - {\hat{X}}_{t} )}^{2} = {\sum }_{t = 1}^{N} {( {X}_{t} - {\sum }_{i = 1}^{p} {W}_{i} {X}_{t - i} )}^{2} \qquad ( 3 )$$

Subsequently, the prediction module 312_1 may obtain partial differentiations of E to W₁ to Wₚ

$$( i . e . , \frac{\partial E}{\partial {W}_{1}} to \frac{\partial E}{\partial {W}_{p}} )$$

respectively and let

$$\frac{\partial E}{\partial {W}_{1}} = \frac{\partial E}{\partial {W}_{2}} = ⋯ \frac{\partial E}{\partial {W}_{p}} = 0.$$

Subsequently, the prediction module 312_1 may obtain W₁ to Wₚ, which satisfy the condition of

$$“ \frac{\partial E}{\partial {W}_{1}} = \frac{\partial E}{\partial {W}_{2}} = ⋯ \frac{\partial E}{\partial {W}_{p}} = 0 ” .$$

Accordingly, the prediction module 312_1 may obtain W₁ to Wₚ, which are capable of minimizing the sum of square of the estimation errors.

Thereafter, in step S514, the prediction module 312_1 may measure the current channel quality of the gateway 204_1. In step S516, the prediction module 312_1 may determine whether the handover occurs in the gateway 204_1. If yes, the prediction module 312_1 may clear the buffer in step S518; and if no, the prediction module 312_1 may store the current channel quality into the buffer in step S520. In step S522, the prediction module 312_1 may determine whether the size of the buffer is greater than or equal to the order. Details regarding steps S516 to S522 may refer to steps S418, S428, S430 and S432 of FIG. 4, which are not repeated hereinafter.

If the size of the buffer is greater than or equal to the order, the prediction module 312_1 may set the order as the maximal order in step S524. On the other hand, if the size of the buffer is less than the order, the prediction module 312_1 may set the order as the size of the buffer in step S526. Thereafter, in step S528, the prediction module 312_1 may calculate the predicted channel quality based on the content of the buffer, the order and the weights. For instance, when the predicted channel quality is the channel quality of a (t+1)^{th} time point, the prediction module 312_1 may apply the WMA mathematical formula

$$( e . g . , {\hat{X}}_{t + 1} = {\sum }_{i = 1}^{p} {W}_{i} {X}_{t - i + 1} )$$

of the foregoing teachings to calculate the predicted channel quality (i.e., \hat{X}ₜ₊₁).

After the predicted channel quality (e.g., \hat{X}ₜ₊₁) is obtained according to the teachings of FIG. 4 and FIG. 5, the prediction module 312_1 may then search the corresponding AMC scheme, and predict the bandwidth of the gateway 204_1 at the (t+1)^{th} time point based on the AMC scheme. For instance, assuming that the AMC scheme corresponding to \hat{X}ₜ₊₁ is 64 QAM (i.e., quadrature amplitude modulation) and a ½ coding rate, the bandwidth corresponding to \hat{X}ₜ₊₁ is, for example, 5.645 mega bit (Mb).

As described above, the bandwidth of the gateway 204_2 may also be predicted according to the foregoing teachings. Referring back to FIG. 3, after the bandwidth of each of the gateways 204_1 to 204_2 is predicted by the prediction module 312_1, in step S320, the calculation module 312_2 may calculate the transmission cost of the each of the gateways 204_1 to 204_2 based on the load condition and the bandwidth of each of the gateways 204_1 to 204_2 and the hop count between each of the gateways and the access point 206_1. The load condition may be represented by, for example, a queue condition, a processor usage rate, a bandwidth usage rate or other similar parameters of the gateways 204_1 to 204_2. The hop count between each of the gateways 204_1 to 204_2 and the access point 206_1 may be determined by the architecture of the vehicles network system 200. For example, in FIG. 2, the hop count between the access point 206_1 and the gateway 204_1 is 3, and the hop count between the access point 206_1 and the gateway 204_2 is 1.

In an embodiment, the transmission cost of each of the gateways 204_1 to 204_2 for routing the access point 206_1 may be represented as:

c(s)=w₁^{(max-h}^{ₛ}⁺¹⁾+w₂×rₛ+w₃×qₛ (4)

wherein hₛ is the hop count between a s^{th} (s is a positive integer) gateway among the gateways 204_1 to 204_2 and the access point 206_1, “max” is a preset maximum hop count, rₛ is the bandwidth of the s^{th} gateway, qₛ is the load condition of the s^{th} gateway, and W₁ to W₃ area plurality of preset weights. The preset maximum hop count may be a positive integer preset by the designers and satisfying specific conditions. For example, in FIG. 2, the hop count between the access point 206_1 and the farthest gateway 204_1 is 3. In this case, the preset maximum hop count cannot be greater than 3.

After the transmission cost of each of the gateways 204_1 to 204_2 for routing to the access point 206_1 is calculated, in step S330, the selection module 312_3 may select the routing gateway among the gateways 204_1 to 204_2 for routing the access point 206_1 according to the transmission cost of each of the gateways 204_1 to 204_2. For example, in an embodiment, the selection module 312_3 may select one having a lowest transmission cost among the gateways 204_1 to 204_2 to serve as the routing gateway for routing the access point 206_1.

Because the calculation module 312_2 takes in consideration of the load condition, the bandwidth and the hop count between each of the gateways and the access point 206_1 while calculating the transmission cost of each of the gateways 204_1 to 204_2, the routing gateway most suitable for routing the access point 206_1 may be located accordingly. Subsequently, the access point 206_1 may directly send the data flows from the served UEs to such routing gateway. Based on the foregoing teachings, the transmission cost of each of the gateways 204_1 to 204_2 for routing the access point 206_2 may be calculated, so that the routing gateway most suitable for routing the access point 206_2 may also be located accordingly, and related description regarding the above is not repeated hereinafter.

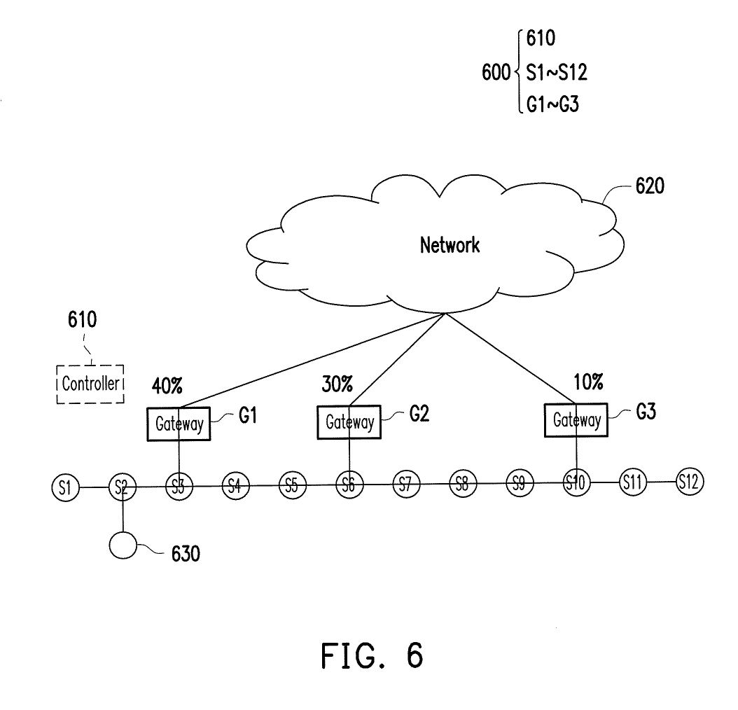

Referring to FIG. 6, FIG. 6 is a schematic diagram for selecting the routing gateway according to the transmission cost according to an embodiment of the present disclosure. In the present embodiment, a vehicle network system 600 includes a controller 610, access points S1 to S12 and gateways G1 to G3. In this example, each of the access points S1 to S12 is disposed on one of vehicles in a fleet of vehicles, and each of the gateways G1 to G3 is disposed on one of the vehicles in said fleet of vehicles. For example, the access point S1 may be disposed on a first vehicle of the fleet of the vehicles. As another example, the access point S5 may be disposed on a fifth vehicle of the fleet of the vehicles. Disposition relationships between the remaining access points and the vehicles should be deduced by analogy, and thus related description thereof is omitted hereinafter. Further, for clearer illustration, although it is not illustrated specifically, the controller 610 may be electrically connected or wirelessly connected to the access points S1 to S12 and the gateways G1 to G3 as similar to illustration of FIG. 2.

In the present embodiment, it is assumed that the controller 610 is configured to select a routing gateway among the gateways G1 to G3 for routing the access point S2 to a network 620. For the access point S2, the load condition and the bandwidth of each of the gateways G1 to G3 and the hop count between each of the gateways and the access point S2 may be represented by Table 1 below.

TABLE 1

| | Hop counts | Bandwidth | Load condition |
|---|---|---|---|
| Gateway G1 | 2 | 5.645 Mb | 40% |
| Gateway G2 | 5 | 5.645 Mb | 30% |
| Gateway G3 | 9 | 5.645 Mb | 10% |

The bandwidth corresponding to each of the gateways G1 to G3 in Table 1 may be obtained by the controller 610 based on the foregoing teachings, which are not repeated hereinafter. Subsequently, the controller 610 may calculate the transmission cost of each of the gateways G1 to G3 for routing the access point S2 based on the formula (4). In the present embodiment, when “max” in the formula (4) is 9 and w₁ to w₃ are 0.9, 0.01 and 1 respectively, the transmission cost of each of the gateways G1 to G3 for routing the access point S2 may be represented by Table 2 below.

TABLE 2

| | Transmission cost |
|---|---|
| Gateway G1 | (0.9)⁽⁹⁻²⁺¹⁾ + 5.645 × 0.01 + 0.4 × 1 = 0.8869 |
| Gateway G2 | (0.9)⁽⁹⁻⁵⁺¹⁾ + 5.645 × 0.01 + 0.3 × 1 = 0.9469 |
| Gateway G3 | (0.9)⁽⁹⁻⁹⁺¹⁾ + 5.645 × 0.01 + 0.1 × 1 = 1.0564 |

In view of Table 2, since the transmission cost of the gate G1 for routing the access point S2 is lower than the transmission costs of the gateways G2 and G3, the controller 610 may select the gateway G1 to serve as the routing gateway for routing the access point S2. Thereafter, the controller 610 may inform the access point S2 of such result by the control flow so that the access point S2 may set a routing table thereof. Accordingly, when the access point S2 receives the data flow from a UE 630 served by the access point S2, the access point S2 may then directly route such data flow to the network 620 through the gateway G1. In other words, the data flow does not go through redundant transmission paths as similar to what illustrated in FIG. 1B.

In other embodiments, the controller 610 may also periodically re-calculate the transmission cost of each of the gateways G1 to G3 for routing the access point S2, so as to select the routing gateway for the access point S2 more properly. Alternatively, the controller 610 may also be set to re-calculate the transmission cost of each of the gateways G1 to G3 for routing the access point S2 at particular moments or in particular sections. Thereafter, the controller 610 may inform the access point S2 of the selected result by the control flow again, so that the access point S2 may correspondingly update the routing table.

Although the description of FIG. 6 takes only the access point S2 as the example, mechanisms used by the controller 610 to select the routing gateway for the access points S1, S3 to S12 may be deduced by analogy, which is not repeated hereinafter.

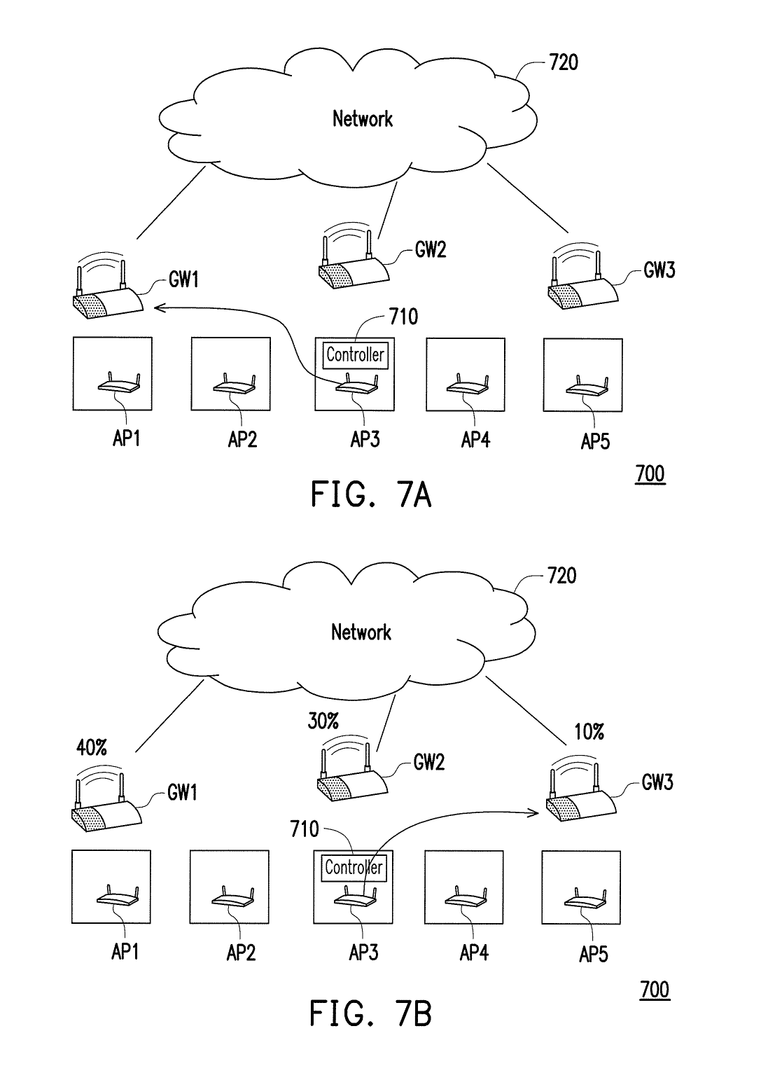

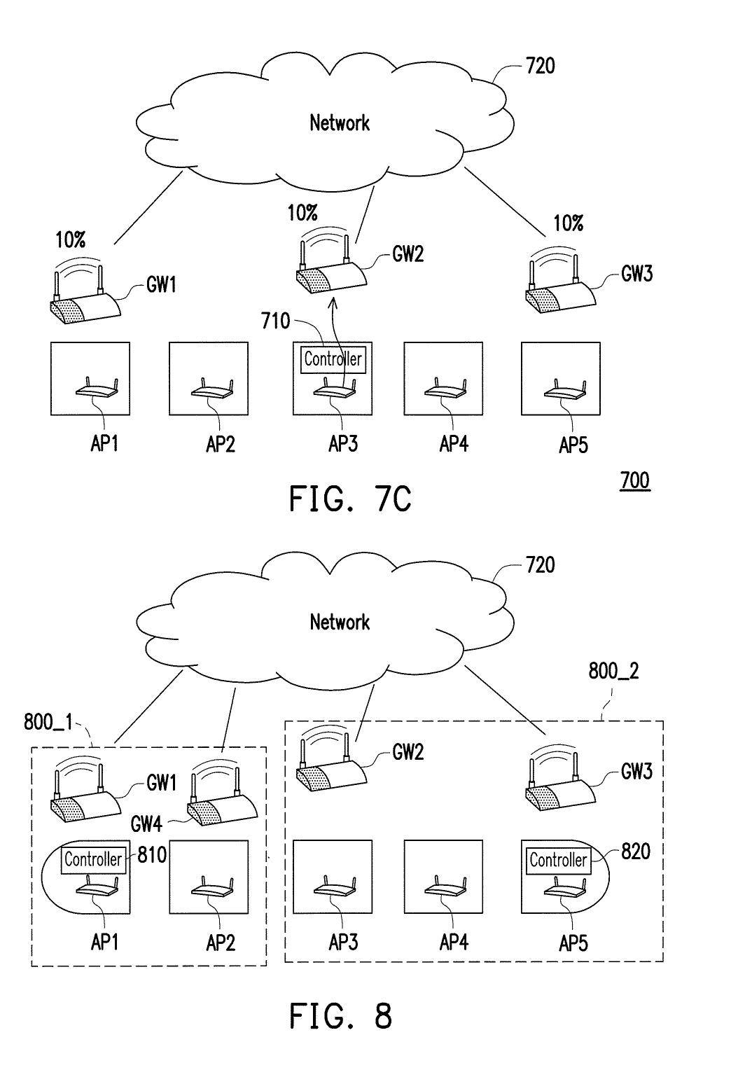

From another perspective, because the calculation for the transmission cost also takes in consideration of the load condition, the bandwidth and the hop count of each of the gateways G1 to G3, not only the data flows of the access points S1 to S12 may be centralized at one of the gateways G1 to G3 but also distributed among the gateways G1 to G3 more evenly. Therefore, the method proposed by the present disclosure may achieve the effectiveness of the load balance among the gateways G1 to G3, as shown in FIG. 7A to FIG. 7C.

FIG. 7A to FIG. 7C are schematic diagrams of the load balance according to multiple embodiments of the present disclosure. In FIG. 7A to FIG. 7C, a vehicles network system 700 includes a controller 710, access points AP1 to AP5 and gateways GW1 to GW3. Each of the access points AP1 to AP5 is disposed on one of vehicles in a fleet of vehicles, and each of the gateways GW1 to GW3 is disposed on one of the vehicles in said fleet of vehicles. Further, the controller 710 may be electrically connected or wirelessly connected to the access points AP1 to AP5 and the gateways GW1 to GW3 as similar to what illustrated in FIG. 2. In order to describe the concept of the following embodiments more clearly, the following descriptions are described by using only the mechanism used by the controller 710 to select the routing gateway for the access point AP3, but the implementation of the present disclosure is not limited to the above. Further, although the controller 710 is disposed on the same vehicle where the access point AP3 is disposed in this examples, it is simply an example instead of limitations to the possible implementation of the present disclosure. In other embodiments, the controller 710 may also be disposed on the other vehicles of the fleet of vehicles based on requirements of the designers.

Referring to FIG. 7A, it is assumed herein that only signals from the gateway GW1 are preferable (i.e., the bandwidth is larger), the controller 710 may select the gateway GW1 to serve as the routing gateway for the access point AP3 so as to route the data flow from the access point AP3 to a network 720.

Referring to FIG. 7B, it is assumed herein that signals from both the gateways GW2 and GW3 are preferable, the controller 710 may determine that the gateway GW3 with a lower load condition (e.g., 10%) has a lower transmission cost for routing the access point AP3. Therefore, the controller 710 may select the gateway GW3 to serve as the routing gateway for the access point AP3.

Referring to FIG. 7C, it is assumed herein that the load conditions and bandwidths of the gateways GW1 to GW3 are all preferable, the controller 710 may select the gateway GW2 having a smallest hop count between the gateway and the access point AP3 to serve as the routing gateway for the access point AP3.

In other embodiments, one fleet of vehicles may also include one or more controllers. In the embodiments where multiple controllers are used, each of the controllers may form a vehicle network configured to select a suitable routing gateway of the access points under control of the same controller.

Referring to FIG. 8, FIG. 8 is a schematic diagram illustrating a vehicles network system having multiple controllers according to an embodiment of the present disclosure. In the present embodiment, a vehicle network 800_1 may include a controller 810, gateways GW1 and GW4 and access points AP1 to AP2. A vehicles network 800_2 includes a controller 820, gateways GW2 to GW3 and access points AP3 to AP5. The vehicles networks 800_1 and 800_2 may be disposed on the same fleet of vehicles. For instance, the vehicles network 800_1 may be disposed on first two vehicles of the fleet of vehicles, and the vehicles network 800_2 may be disposed on last three vehicles of the fleet of vehicles. In the vehicles network 800_1, the controller 810 may select the suitable routing gateway among the gateways GW1 and GW4 for the access points AP1 to AP2. Further, in the vehicles network 800_2, the controller 820 may select the suitable routing gateway among the gateways GW2 to GW3 for the access points AP3 to AP5. Further, although the controllers 810 and 820 are disposed on the same vehicles where the access point AP1 and AP5 are respectively disposed, they are simply examples instead of limitations to the possible implementation of the present disclosure. In other embodiments, the controllers 810 and 820 may also be disposed on the other vehicles of the fleet of vehicles based on requirements of the designers. Furthermore, the controller in one network system may control all or part of gateways among the gateways and all or part of access points among the access points.

In addition, although at most three gateways are used as examples in each of the foregoing embodiments, the method proposed by the present disclosure may also be adapted by a vehicle network system having more than three gateways.

In summary, according to the routing gateway selecting method proposed by the present disclosure, the controller additionally disposed on the fleet of vehicles may used to calculate the transmission cost of each of the gateways for routing the access point, which may be used to select the suitable routing gateway for the access point. Because the controller takes in consideration of the load condition, the bandwidth and the hop count between each of the gateways and the access point while calculating the transmission cost of each of the gateways, the data flows from the UEs may be distributed among the gateways more evenly, so as to achieve the effectiveness of the load balance. Furthermore, since the data flows from the UEs do not go through the load balance controller for collectively distributing the routing gateway as mentioned in the description of FIG. 1B, the network congestion on the vehicle network may also be solved at the same time.

It will be apparent to those skilled in the art that various modifications and variations can be made to the disclosed embodiments. It is intended that the specification and examples be considered as exemplary only, with a true scope of the disclosure being indicated by the following claims and their equivalents

1. A routing gateway selecting method, adapted to a controller configured to select a routing gateway among a plurality of gateways for routing an access point, and comprising:
predicting a bandwidth of each of the gateways;
calculating a transmission cost of each of the gateways for routing the access point based on a load condition and the bandwidth of each of the gateways and a hop count between each of the gateways and the access point; and
selecting the routing gateway among the gateways for routing the access point according to the transmission cost of each of the gateways,
wherein the controller is disposed on a fleet of vehicles configured by a plurality of vehicles.

2. The routing gateway selecting method of claim 1, wherein the controller is a software-defined network controller, the controller utilizes a control signal to control and request the gateways to provide the load condition, and the access point and the gateways are disposed on the fleet of vehicles.

3. The routing gateway selecting method of claim 1, further comprising:
establishing a channel quality estimation model of each of the gateways based on historical information of both the gateways and the fleet of vehicles; and
obtaining current movement information of the fleet of vehicles and current channel information of each of the gateways.

4. The routing gateway selecting method of claim 3, wherein the step of predicting the bandwidth of each of the gateways further comprises:
predicting a channel quality of each of the gateways based on the current movement information, the current channel information and the channel quality estimation model of each of the gateways; and
estimating the bandwidth of each of the gateways according to the channel quality of each of the gateways.

5. The routing gateway selecting method of claim 4, wherein the channel quality comprises a carrier to interference and noise ratio, a carrier to noise ratio, a signal to noise ratio and a signal to interference and noise ratio, and the step of estimating the bandwidth of each of the gateways according to the channel quality of each of the gateways further comprises:
searching an adaptive modulation and coding scheme corresponding to the channel quality of each of the gateways, and estimating the bandwidth of each of the gateways based on the adaptive modulation and coding scheme.

6. The routing gateway selecting method of claim 4, further comprising: obtaining a channel quality estimated value, and predicting the channel quality based on an autoregressive model mechanism.

7. The routing gateway selecting method of claim 4, further comprising: calculating a plurality of weights, and predicting the channel quality based on a weighted moving average mechanism.

8. The routing gateway selecting method of claim 1, wherein the transmission cost of a s^{th} gateway among the gateways for routing the access point is represented by:
c(s)=w₁^{(max-h}^{ₛ}⁺¹⁾+w₂×rₛ+w₃×qₛ
wherein hₛ is the hop count between the access point and the s^{th} gateway, max is a preset maximum hop count, rₛ is the bandwidth of the s^{th} gateway, qₛ is the load condition of the s^{th} gateway, and W₁ to W₃ are preset weights.

9. The routing gateway selecting method of claim 1, wherein the step of selecting the routing gateway among the gateways for routing the access point according to the transmission cost of each of the gateways further comprises:
selecting one having a lowest transmission cost among the gateways to serve as the routing gateway for routing the access point.

10. The routing gateway selecting method of claim 1, wherein the controller is electrically connected or wirelessly connected to the access point and the gateways.

11. The routing gateway selecting method of claim 1, wherein the vehicles comprise: cars of a railway train, cars of a high-speed railway train, or cars of a motorcade having multiple cars.

12. A controller, configured to select a routing gateway among a plurality of gateways for routing an access point, and comprising:
an access unit, accessing a plurality of modules; and
a processing unit, electrically connected to the access unit for accessing and executing the modules, and the modules comprising:
a prediction module, predicting a bandwidth of each of the gateways;
a calculation module, calculating a transmission cost of each of the gateways based on a load condition and the bandwidth of each of the gateways and a hop count between each of the gateways and the access point; and
a selection module, selecting the routing gateway among the gateways for routing the access point according to the transmission cost of each of the gateways,
wherein the controller is disposed on a fleet of vehicles configured by a plurality of vehicles.

13. The controller of claim 12, wherein the controller is a software-defined network controller, and the controller utilizes a control signal to control and request the gateways to provide the load condition.

14. The controller of claim 12, wherein the access point is disposed on the fleet of vehicles.

15. The controller of claim 14, wherein each of the gateways is disposed on the fleet of vehicles.

16. The controller of claim 12, wherein the prediction module is further configured for:
establishing a channel quality estimation model of each of the gateways based on historical information of both the gateways and the fleet of vehicles; and
obtaining current movement information of the fleet of vehicles and current channel information of each of the gateways.

17. The controller of claim 16, wherein the prediction module is configured for:
predicting a channel quality of each of the gateways based on the current movement information, the current channel information and the channel quality estimation model of each of the gateways; and
estimating the bandwidth of each of the gateways according to the channel quality of each of the gateways.

18. The controller of claim 17, wherein the channel quality comprises a carrier to interference and noise ratio, a carrier to noise ratio, a signal to noise ratio and a signal to interference and noise ratio, and the prediction module is configured for:
searching an adaptive modulation and coding scheme corresponding to the channel quality of each of the gateways, and estimating the bandwidth of each of the gateways based on the adaptive modulation and coding scheme.

19. The controller of claim 17, wherein the prediction module obtains a channel quality estimated value, and predicting the channel quality based on an autoregressive model mechanism.

20. The controller of claim 17, wherein the prediction module calculates a plurality of weights, and predicting the channel quality based on a weighted moving average mechanism.

21. The controller of claim 12, wherein the transmission cost of a s^{th} gateway among the gateways for routing the access point is represented by:
c(s)=w₁^{(max-h}^{ₛ}⁺¹⁾+w₂×rₛ+w₃×qₛ
wherein hₛ is the hop count between the access point and the s^{th} gateway, max is a preset maximum hop count, rₛ is the bandwidth of the s^{th} gateway, qₛ is the load condition of the s^{th} gateway, and W₁ to W₃ are preset weights.

22. The controller of claim 12, wherein the selection module is configured to select one having a lowest transmission cost among the gateways to serve as the routing gateway for routing the access point.

23. The controller of claim 12, wherein the controller is electrically connected or wirelessly connected to the access point and the gateways.

24. The controller of claim 12, wherein the vehicles comprise: cars of a railway train, cars of a high-speed railway train, or cars of a motorcade having multiple cars.

25. A vehicles network system, comprising:
a plurality of access points;
a plurality of gateways;
one or more controllers, controlling all or part of gateways among the gateways and all or part of access points among the access points, and configured for:
predicting a bandwidth of each of the controlled gateways;
calculating a transmission cost of each of the controlled gateways for routing each of the controlled access points based on a load condition and the bandwidth of each of the controlled gateways and a hop count between each of the controlled gateways and each of the controlled access points; and
selecting a routing gateway among the controlled gateways for routing each of the controlled access points according to the transmission cost of each of the controlled gateways for routing each of the controlled access points,
wherein the one or more controllers are disposed on a fleet of vehicles configured by a plurality of vehicles.

26. The vehicles network system of claim 25, wherein the one or more controllers are a software-defined network controller, and the one or more controllers utilize a control signal to control and request the controlled gateways to provide the load condition.

27. The vehicles network system of claim 25, wherein each of the access points is disposed on the fleet of vehicles.

28. The vehicles network system of claim 27, wherein each of the gateways is disposed on the fleet of vehicles.

29. The vehicles network system of claim 25, wherein the one or more controllers are further configured for:
establishing a channel quality estimation model corresponding to each of the controlled gateways based on historical information of both the controlled gateways and the fleet of vehicles; and
obtaining current movement information of the fleet of vehicles and current channel information of each of the controlled gateways.

30. The vehicles network system of claim 29, wherein the one or more controllers are configured for:
predicting a channel quality of each of the controlled gateways based on the current movement information, the current channel information and the corresponding channel quality estimation model of each of the controlled gateways; and
estimating the bandwidth of each of the controlled gateways according to the corresponding channel quality of each of the controlled gateways.

31. The vehicles network system of claim 30, wherein the channel quality comprises a carrier to interference and noise ratio, a carrier to noise ratio, a signal to noise ratio and a signal to interference and noise ratio, and the one or more controllers are further configured for:
searching an adaptive modulation and coding scheme corresponding to the channel quality of each of the controlled gateways, and estimating the bandwidth of each of the gateways based on the adaptive modulation and coding scheme.

32. The vehicles network system of claim 30, wherein the one or more controllers obtains a channel quality estimated value, and predicting the channel quality based on an autoregressive model mechanism.

33. The vehicles network system of claim 30, wherein the one or more controllers calculates a plurality of weights, and predicting the channel quality based on a weighted moving average mechanism.

34. The vehicles network system of claim 25, wherein the transmission cost of a s^{th} gateway among the gateways for routing each of the access points is represented by:
c(s)=w₁^{(max-h}^{ₛ}⁺¹⁾+w₂×rₛ+w₃×qₛ
wherein hₛ is the hop count between the access point and the s^{th} gateway, max is a preset maximum hop count, rₛ is the bandwidth of the s^{th} gateway, qₛ is the load condition of the s^{th} gateway, and W₁ to W₃ are preset weights.

35. The vehicles network system of claim 25, wherein the one or more controllers are configured to select one having a lowest transmission cost among the controlled gateways to serve as the routing gateway for routing each of the controlled access points.

36. The vehicles network system of claim 25, wherein the one or more controller are electrically connected or wirelessly connected to the controlled access points and the controlled gateways.

37. The vehicles network system of claim 25, wherein the vehicles comprise: cars of a railway train, cars of a high-speed railway train, or cars of a motorcade having multiple cars.
